(19) United States
(12) Patent Application Publication
(10) Pub. No.: US 2019/0375046 A1
(43) Pub. Date: Dec. 12, 2019

(54) Method for Welding Components

(71) Applicant: Bayerische Motoren Werke Aktiengesellschaft, Muenchen (DE)

(72) Inventors: Alexander GRIMM, Karlsfeld (DE); Maik HAMMER, Bruckberg (DE); Johann NIEKERK, Muenchen (DE)

(21) Appl. No.: 16/546,534

(22) Filed: Aug. 21, 2019

Related U.S. Application Data
(63) Continuation of application No. PCT/EP2018/057097, filed on Mar. 21, 2018.

(30) Foreign Application Priority Data
Apr. 4, 2017 (DE) 10 2017 205 765.3

(51) Int. Cl. B23K 26/0622; B23K 26/322; B23K 26/244

(52) U.S. Cl. CPC B23K 26/0622; B23K 2103/04; B23K 26/244; B23K 26/322

(57) ABSTRACT

A method for welding components includes providing a first component and a second component, bringing the two components together, welding the two components by a laser beam, wherein a multiplicity of welding pulses are generated through the repeated activation and deactivation of the laser beam, with each welding pulse being interrupted by welding-free rest intervals in which the laser beam is deactivated. Each welding pulse creates a local welding area, in which material of the two components is melted and fused in a locally limited manner, wherein individual welding areas of those generated by the welding pulses overlap.

### CROSS REFERENCE TO RELATED APPLICATIONS

This application is a continuation of PCT International Application No. PCT/EP2018/057097, filed Mar. 21, 2018, which claims priority under 35 U.S.C. § 119 from German Patent Application No. 10 2017 205 765.3, filed Apr. 4, 2017, the entire disclosures of which are herein expressly incorporated by reference.

### BACKGROUND AND SUMMARY OF THE INVENTION

The present invention relates to a method for welding components.

Such a method is known from the older, not previously published German patent application DE 10 2016 206 012.0. In this older, not previously published German patent application, the welding of two vehicle chassis components by use of a pulsed laser beam is described.

The welding of sheet metal components using a laser beam has already been known for a long time. Here, a laser beam is typically moved with a continuous advance movement relative to the two components that are to be welded together, which results in melting and the melting together of the materials of the two components. The laser beam “drags” a “melt train” of several millimeters (for example 10 mm) behind it on account of its advance movement, that is to say in a region of several millimeters behind the current position of the laser beam, the material is still liquid.

A particular problem is the welding of zinc-plated steel sheets. This is because the zinc layer already evaporates at approximately 960° Celsius and then escapes into the environment in the form of vapor and deposits itself into the molten metal material that is located underneath, which can result in porosities. In the case of metal sheets that are to be welded and are located next to one another, evaporating zinc from the abutment region of the sheets cannot easily escape into the environment, which can result in the deposition of relatively large amounts of zinc in the molten metal and consequently in undesirably strong porosities, holes or possibly ejections and spatter.

Laser beam welding has, for quality reasons, therefore only been used to date in “dry regions” and not in components or component regions that are exposed to a large extent to moisture or spray water, since the risk of corrosion here has been considered to date to be too high.

It is an object of the invention to provide a laser welding method that results in high-quality welding connections and is also suitable for use in vehicle chassis construction.

This and other objects are achieved by the method for welding components according to the claimed invention.

The starting point of the invention is a method for welding a first component and a second component together. The provided components are initially placed next to one another and are subsequently welded together by use of a laser beam. The welding is done in pulsed fashion, that is to say the laser beam is repeatedly turned on and off, which produces a large number of welding pulses. The individual welding pulses are in each case interrupted by weld-free rest intervals in which the laser beam is switched off. According to the invention, a slit is produced in the first component that runs through the first component. The laser beam is directed during the welding into the region of the slit. The slit can be straight or curved. The profile of the slit corresponds to the profile of the weld seam that is to be produced.

The slit is preferably produced before the two components are connected or brought together. The production of the slit can be accomplished for example by laser cutting.

The width of the slit can be selected, in dependence on the material of the first component (that is to say in dependence on the material and thickness thereof), to be very narrow (for example a few tenths of a millimeter up to several millimeters). The width of the slit does not necessarily have to be constant over the length of the slit but can also vary over the length of the slit.

Welding is preferably accomplished such that the weld seam connects to the two mutually opposite “walls” of the slit that are spaced apart from one another. The width of the slit is preferably smaller than the width of the “weld pool” or the width of the weld seam being produced, such that the slit is completely welded closed and the lateral material of the first component is melted with and connected to the material of the second component. By forming a slit, uniform melting of the two components with an overlap connection is made possible with comparatively low introduction of energy even in the case of pulsed welding.

According to the invention, each welding pulse produces a local welding area in which material of the two components is melted and melted together in a locally delimited fashion. The term “welding area” is understood to mean a relatively small, for example “point-shaped” or circular region, although other geometries are of course also conceivable. Such a welding area can in terms of order of magnitude for example lie in a (diameter) region between a few micrometers and a few millimeters (for example up to 3 or 4 or 5 mm).

One aspect of the invention is that individual ones of the welding areas produced by the welding pulses overlap. In this way it is possible to build a contiguous weld seam from a large number of mutually overlapping welding areas.

In contrast to conventional laser welding methods, in which the laser beam is moved relative to the components to be welded with a specific advance speed, it is possible according to the invention for the laser beam to remain stationary relative to the two components during the individual welding pulses. A welding area currently being produced can be irradiated with laser light permanently, in particular permanently throughout or over the entire area, during the welding pulse. If no relative movement of the laser beam with respect to the components takes place during the welding, there will be no dragging of a weld train either, in contrast to the prior art.

Due to the pulsed introduction of energy, the material of the components that are to be welded together is melted in an extremely focused and locally highly delimited fashion. The material is thus significantly heated substantially only in the region that is currently being melted by the laser beam. There is hardly any temperature increase even at a distance of a few millimeters from the current welding area. This has the advantage that components, in which temperature sensitive components, such as for example a plastics component or an adhesive layer or the like, are located relatively close to the welding area currently being produced, can still be welded together without difficulty.

As already mentioned, it is possible for individual ones of the welding areas produced by the welding pulses to overlap to form a contiguous, fluid-tight weld seam. According to the invention, the laser beam can be positioned such that a welding area currently being produced overlaps with an already produced or welded welding area in the manner of “scales” or a seam.

A welding area currently being produced that overlaps with an already produced welding area is preferably produced or melted only when the already produced welding area that the welding area to be produced is to partially overlap has already solidified again or has largely solidified.

Welding areas can be produced sequentially one after the other, specifically in an order such that the welding areas which are produced immediately after the other overlap in the manner of scales. In other words, this means that a welding area currently being produced overlaps with a welding area which was produced immediately before the last rest interval. In this method, welding areas are thus sequentially produced one after the other, in a manner similar to a pearl necklace.

Alternatively, it is also possible that a welding area currently being produced is located at a distance from a welding area that was produced immediately before the last rest interval. The welding area currently being produced is thus free of overlap with respect to the welding area that was produced immediately before the last rest interval. As a result, the local introduction of heat or the local temperature increase in the components that are to be welded together can be minimized even further. Nevertheless, it is also possible in this way to produce a contiguous, fluid-tight weld seam; in contrast to the above-described method, the individual welding areas of the weld seam are not placed one next to the preceding other but in a different order.

The pulse durations of the large number of welding pulses can lie for example in a range between 0.1 ms and 100 ms, or in a range between 0.1 ms and 50 ms, or in a range between 0.1 ms and 20 ms. The pulse durations of the large number of welding pulses preferably lie in a range between 1.0 ms and 20 ms, or 1.0 ms and 10 ms. Highly local melting is possible with such pulse durations with comparatively low overall heat introduction into the component.

The pulse durations of the large number of welding pulses can in each case be of equal length. However, this does not have to be the case. The pulse durations of the large number of welding pulses can also be of different length. For example, it may be reasonable to work with a longer welding pulse duration in regions in which the components that are to be welded together have a greater component thickness than in component regions in which the component thicknesses are lower.

The power density of the laser beam used for the invention can lie for example in the range between 10⁴ Watt/cm² and 10¹⁰ Watt/cm². Here, the power density of the large number of welding pulses can be of the same or of different magnitude. Analogously to the length of the pulse durations, “weld points” in regions in which the components to be welded together have a greater component thickness can for example be larger than in other regions.

Furthermore, the power density of a welding pulse can be changed during the welding pulse, for example by way of:

changing the laser power with constant beam cross section,

changing the beam cross section with constant laser power, or

changing the laser power and the beam cross section.

According to a development of the invention, a laser beam that has a beam diameter or a beam width that lies in the range between 40 μm and 4 mm is used. The beam diameter or the beam width of the laser beam can be identical or different in the case of the large number of welding pulses even in the case of this parameter. Depending on the use, it may be desirable to produce a weld seam that has, over its entire length, a substantially identical weld seam width or a different weld seam width, which can be set by varying the beam diameter or the beam width of the laser beam.

With respect to the cross section of the laser beam, it is possible to operate for example with a laser beam having a circular beam cross section. However, this does not necessarily have to be the case. In principle, other cross-sectional shapes, such as for example a laser beam having a rectangular or oval beam cross section, are also contemplated.

Experiments have shown that very high-quality weld connections can be attained if a “repetition rate” is used that lies in a range between 200 Hz and 10 kHz. “Repetition rate” is understood to mean the number of welding pulses per second. For example, if welding pulses of a length of 5 ms and a rest interval of 15 ms are employed, this produces a period duration T of 20 ms, corresponding to a repetition rate of 1/0.02 s or 50 Hz.

The method according to the invention can be used to weld together metal components, in particular metal sheet components, as are used for example in vehicle chassis construction. The method according to the invention, however, is not limited to metal components, but it is possible in principle to also use it for welding plastics components, in particular components made of a thermoplastic material.

The method according to the invention is also highly suitable for welding components in which at least one of the components is partially or completely coated with a coating, as is the case for example in the case of zinc-plated steel sheets. Preferably, a component with a coating having a melting or evaporation temperature that is lower than the melting or evaporation temperature of the component material onto which the coating is applied is used for this. This is the case for example in zinc-plated steel sheets, in which the zinc layer already evaporates at temperatures of approximately 960° Celsius.

The method according to the invention is not only suitable for welding conventional steel or aluminum sheets, but in particular also for welding together stainless steel sheet components. Alternatively, the method according to the invention can also be used to weld a steel or aluminum component to a cast component. For example, a steel or aluminum bushing or a steel or aluminum bolt can be welded onto a cast component or can be welded into a recess of a cast component using the method according to the invention. Where the description mentions “aluminum,” this also comprises “aluminum alloys.”

The method according to the invention is suitable in particular for welding together components having a thickness in the weld region of between 0.3 mm and 5 mm, in particular in a range between 0.3 mm and 3 mm.

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 shows the welding of two sheet metal components in a schematic representation.

FIG. 2 shows the sequential production of a weld seam from a large number of welding areas.

FIG. 3 is a diagram describing the laser power over time.

### DETAILED DESCRIPTION OF THE DRAWINGS

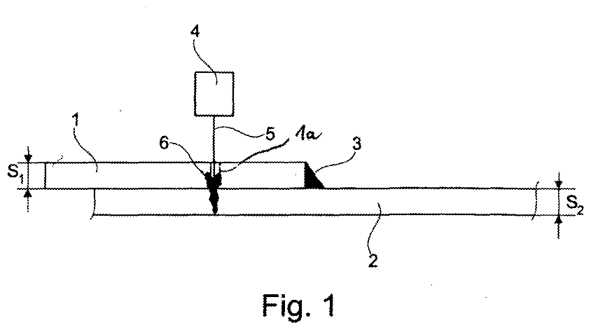

FIG. 1 shows two metal sheets 1, 2 which are located one next to the other, wherein the thickness of the sheet 1 is s₁ and the thickness of the sheet 2 is s₂. s₁ and s₂ may for example lie in the range between 0.3 mm and 3 mm. In the peripheral region of the sheet 1, the two sheets 1, 2 have already been welded together here using a fillet weld 3. Prior welding together by using the fillet weld 3 is not absolutely necessary, however.

In the first sheet 1, a slit 1a is provided that runs through the first component 1. The slit 1a can have a width of a few tenths of a millimeter up to a few millimeters.

Using a laser welding device 4 that produces a laser beam 5, the two metal sheets 1, 2 are welded together additionally using a (butt) weld 6. The laser beam 5 is directed here such that it penetrates the slit 1a and melts material of the two components 1, 2 and welds them together.

The laser welding device 4 is here operated in pulsed fashion, that is to say by periodically switching the laser beam 5 on and off, a large number of welding pulses are produced successively that are interrupted in each case by weld-free rest intervals.

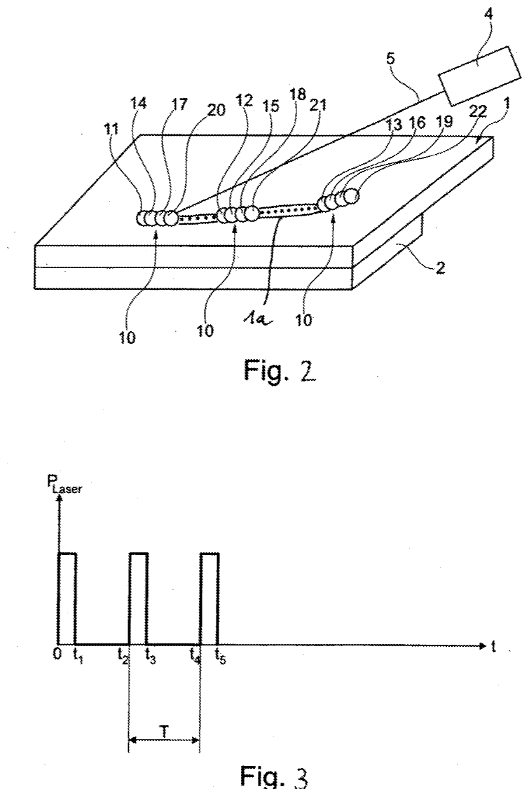

FIG. 2 shows two metal sheets 1, 2 located one on top of the other, which are connected together using a weld seam 10 which is currently being produced. The slit 1a provided in the first component 1 can be clearly seen.

The weld seam 10 is here sequentially built up by way of individual welding areas that overlap one another in a “scale-like” manner. In order to locally delimit the introduction of heat produced by the laser beam 5 into the metal sheets 1, 2 as much as possible, the individual welding arms are possibly not all produced one next to the other or in succession. For example, the welding areas can be produced successively in the order given by the reference signs 11-22. After the welding area 11 has been produced, it can cool. The welding area 12 that is produced after the welding area 11 has a sufficiently large distance from the welding area 11 such that the heat introduction into the welding area 12 substantially does not influence the cooling of the welding area 11, etc.

FIG. 3 describes the pulsed welding according to the invention using a diagram, in which the laser power P_{Laser} is plotted over time t. A first welding pulse extends from the time point 0 up to the time point t₁. This is followed by a rest interval of the length [t₁, t₂].

This is followed by a further welding pulse of the length [t₂, t₃], which in turn is followed by a rest interval of the length [t₃, t₄]. The period duration, that is to say the length of a welding pulse and a subsequent rest interval, is thus T=[t₂, t₄].

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A method for welding first and second components together, the method comprising the acts of:
placing the first and second components next to one another;
welding the first and second components using a laser beam, wherein a large number of welding pulses that are in each case interrupted by weld-free rest intervals in which the laser beam is switched off are produced by repeatedly turning the laser beam on and off,
wherein
a slit is produced in the first component that runs through the first component,
the laser beam is directed into a region of the slit during the welding,
each welding pulse produces a local welding area in which material of the first and second components is melted and melted together in a locally delimited fashion, wherein
individual ones of the welding areas produced by the welding pulses overlap.

2. The method according to claim 1, wherein
the laser beam remains stationary relative to the first and second components during the individual welding pulses such that the respective welding area is irradiated with laser light permanently throughout during a welding pulse.

3. The method according to claim 1, wherein
individual ones of the welding areas produced by the welding pulses overlap one another to form a contiguous, fluid-tight weld seam.

4. The method according to claim 1, wherein
the laser beam is positioned such that a welding area currently being produced overlaps with a welding area already welded.

5. The method according to claim 4, wherein
a welding area currently being produced that overlaps with a welding area already produced is produced only when the welding area already produced has already solidified or has largely solidified.

6. The method according to claim 4, wherein
a welding area currently being produced overlaps with a welding area that was produced immediately before the last rest interval.

7. The method according to claim 1, wherein
a welding area currently being produced is located at a distance from a welding area that was produced immediately before the last rest interval, and is thus overlap-free with respect to the welding area that was produced immediately before the last rest interval.

8. The method according to claim 1, wherein
the pulse durations of the large number of welding pulses lie in the range between:
0.1 ms to 100 ms,
0.1 ms to 50 ms,
0.1 ms to 20 ms,
1 ms to 20 ms, or
1 ms to 10 ms.

9. The method according to claim 1, wherein
the pulse durations of the large number of welding pulses are of equal length.

10. The method according to claim 1, wherein
the pulse durations of the large number of welding pulses are of different length.

11. The method according to claim 1, wherein
a power density of the laser beam lies in the range between 10⁴ Watt/cm² and 10¹⁰ Watt/cm².

12. The method according to claim 11, wherein
the power density of the large number of welding pulses is of the same magnitude.

13. The method according to claim 11, wherein
the power density of the large number of welding pulses is of different magnitude.

14. The method according to claim 1, wherein
the laser beam has a beam diameter or a beam width that lies in the range between 40 μm and 4 mm.

15. The method according to claim 14, wherein
the beam diameter or the beam width of the laser beam is in each case the same in the case of the large number of welding pulses.

16. The method according to claim 14, wherein
a laser beam is used that has a circular beam cross section.

17. The method according to claim 14, wherein
the beam diameter or the beam width of the laser beam differs in the case of individual welding pulses of the large number of welding pulses.

18. The method according to claim 1, wherein
the welding is performed with a repetition rate in a range between 200 Hz and 10 kHz.

19. The method according to claim 1, wherein
metal components are used as the first and second components.

20. The method according to claim 1, wherein
plastics components made of a thermoplastic material are used as the first and second components.

21. The method according to claim 1, wherein
at least one of the first and second components is a component that is partially or completely coated with a coating.

22. The method according to claim 21, wherein
a component with a coating having a melting or evaporation temperature that is lower than the melting or evaporation temperature of the component material onto which the coating is applied is used.

23. The method according to claim 1, wherein
a steel sheet component or an aluminum component or a component made of an aluminum alloy is used as at least one of the first and second components.

24. The method according to claim 1, wherein
a zinc-plated component is used as at least one of the first and second components.

25. The method according to claim 1, wherein
the first component is a cast component, and
the second component is a component made of a different material, which is welded onto the cast component or is welded into the cast component.

26. The method according to claim 1, wherein
the first component is a sphere made of steel, aluminum or a thermoplastic material, which is welded onto the second component.

27. The method according to claim 26, wherein
in a placement region of the sphere on the second component, a weld seam extending in the placement region around the sphere is produced by the large number of welding areas.

28. The method according to claim 1, wherein
the thickness of the first component and/or the thickness of the second component lies in a range between 0.3 mm to 5 mm.

29. The method according to claim 1, wherein
at least one of the first and second components is a chassis component of a vehicle to be produced.

30. The method according to claim 1, wherein
a power density of a welding pulse is changed during the welding pulse by way of:
(i) changing the laser power with constant beam cross section,
(ii) changing the beam cross section with constant laser power, or
(iii) changing the laser power and the beam cross section.
